(19) United States
(12) Patent Application Publication
(10) Pub. No.: US 2022/0029481 A1
(43) Pub. Date: Jan. 27, 2022

(54) ROTOR ASSEMBLIES OF WATER PUMPS

(71) Applicant: INTEX INDUSTRIES XIAMEN CO. LTD, Fujian (CN)

(72) Inventors: Zhi Xiong Huang, Fujian (CN); Ying Biao Zhang, Fujian (CN); Yaw Yuan Hsu, Fujian (CN)

(21) Appl. No.: 17/299,526

(22) PCT Filed: Nov. 27, 2019
(86) PCT No.: PCT/IB2019/060245

§ 371 Date: Jun. 3, 2021

(30) Foreign Application Priority Data
Dec. 4, 2018 (CN) 201822026470.1
Dec. 4, 2018 (CN) 201822026868.5
Dec. 4, 2018 (CN) 201822026990.2
Dec. 4, 2018 (CN) 201822027003.0

(51) Int. Cl. H02K 1/27; H02K 5/10; H02K 15/12; F04D 29/046

(52) U.S. Cl. CPC H02K 1/2706; F04D 29/046; H02K 15/12; H02K 5/10

(57) ABSTRACT

A rotor assembly of a water pump is provided including a rotor body, an upper bearing, a lower bearing, a magnet, an impeller, and a shaft. The rotor assembly also includes a rotor shaft core that ensures concentricity of the upper bearing, the lower bearing, the magnet, and the shaft. The present disclosure also provides a manufacturing method that involves overmolding the rotor body onto the rotor shaft core to encapsulate the magnet.

### CROSS REFERENCE TO RELATED APPLICATION

This application claims priority to the following Chinese patent applications, the disclosures of which are hereby expressly incorporated by reference herein in their entireties:

| Application No. | Filing Date |
|---|---|
| CN201822026470.1 | DEC. 4, 2018 |
| CN201822026868.5 | DEC. 4, 2018 |
| CN201822026990.2 | DEC. 4, 2018 |
| CN201822027003.0 | DEC. 4, 2018 |

### FIELD OF THE DISCLOSURE

The present disclosure relates to water pumps. More particularly, the present disclosure relates to rotor assemblies of water pumps, and to methods for manufacturing and operating the same.

### BACKGROUND OF THE DISCLOSURE

FIG. 1 shows a prior art rotor assembly 100′ for a water pump. The rotor assembly 100′ includes a rotor body 110′ with an axial through hole 112′, an upper bearing 120′ supported by an upper end of the rotor body 110′, a lower bearing 130′ supported by a lower end of the rotor body 110′, a magnet 140′encapsulated by the rotor body 110′, an impeller 150′ coupled to the upper end of the rotor body 110′, and a shaft 160′ extending through the through hole 112′ of the rotor body 110′, the upper bearing 120′, and the lower bearing 130′. The rotor body 110′ and the impeller 150′ may be constructed of plastic materials, while the upper bearing 120′, the lower bearing 130′, and the shaft 160′ may be constructed of non-plastic (e.g., ceramic) materials.

The rotor assembly 100′ may be manufactured by injection molding the rotor body 110′ around the upper bearing 120′ and the magnet 140′, pressing the lower bearing 130′ into the lower end of the molded rotor body 110′ in a friction-fit arrangement, and injection molding the impeller 150′ around the upper end of the molded rotor body 110′. This manufacturing process may be time consuming and expensive. Also, it may be difficult to ensure that the magnet 140′ is fully encapsulated by the rotor body 110′ during the manufacturing process. Further, it may be difficult to ensure that the bearings 120′, 130′ are concentric and in axial alignment with the shaft 160′. Thus, the rotor assembly 100′ may suffer from poor manufacturing yields, uneven operational stresses, vibrations, increased wear, and shortened service life.

### SUMMARY

The present disclosure provides a rotor assembly of a water pump. The rotor assembly includes a rotor body, an upper bearing, a lower bearing, a magnet, an impeller, and a shaft. The rotor assembly also includes a rotor shaft core that ensures concentricity of the upper bearing, the lower bearing, the magnet, and the shaft. The present disclosure also provides a manufacturing method that involves overmolding the rotor body onto the rotor shaft core to encapsulate the magnet.

According to an exemplary embodiment of the present disclosure, a rotor assembly is provided including a rotor shaft core defining a through hole configured to receive a shaft, a magnet, a rotor body overmolded onto the rotor shaft core to encapsulate the magnet between the rotor body and the rotor shaft core, an impeller coupled to the rotor body, an upper bearing defining a through hole in axial alignment with the through hole of the rotor shaft core, and a lower bearing defining a through hole in axial alignment with the through hole of the rotor shaft core.

In certain embodiments, the upper bearing and the lower bearing are supported by the rotor body and configured to rotate about the shaft.

In certain embodiments, the through hole of the rotor shaft core has a smaller diameter than the upper bearing and the lower bearing such that the shaft contacts the upper bearing and the lower bearing without contacting the rotor shaft core.

In certain embodiments, the rotor shaft core includes an axial portion and a radial portion that extends radially outward from the axial portion to support the magnet. The axial portion of the rotor shaft core may include a first plurality of protrusions that extend radially outward toward the magnet, and the rotor body may occupy areas between the first plurality of protrusions. The radial portion of the rotor shaft core may include a second plurality of protrusions that extend axially toward the magnet, and the rotor body may occupy areas between the second plurality of protrusions.

In certain embodiments, the rotor shaft core includes an enlarged upper rim that receives the upper bearing and an enlarged lower rim that receives the lower bearing.

In certain embodiments, the rotor body and the impeller form an integral one-piece structure.

According to another exemplary embodiment of the present disclosure, a rotor assembly is provided including a magnet, a rotor shaft core defining a through hole configured to receive a shaft, the rotor shaft core maintaining concentricity between the magnet and the through hole, a rotor body overmolded onto the rotor shaft core to encapsulate the magnet between the rotor body and the rotor shaft core, and an impeller coupled to the rotor body.

In certain embodiments, the rotor assembly further includes an upper bearing configured to support an upper end of the shaft, and a lower bearing configured to support a lower end of the shaft.

In certain embodiments, the upper and lower bearings are supported by the rotor body such that the upper and lower bearings rotate with the rotor body. The rotor shaft core may include an enlarged upper rim that receives the upper bearing and an enlarged lower rim that receives the lower bearing.

In certain embodiments, the upper and lower bearings are spaced apart from the rotor body such that the rotor body rotates relative to the upper and lower bearings.

In certain embodiments, the rotor assembly further includes a flexible bearing casing around one or more of the upper and lower bearings.

In certain embodiments, the rotor body and the impeller form an integral one-piece structure.

In certain embodiments, the rotor body is a two-piece structure including an inner body portion positioned between the magnet and the rotor shaft core and an outer body portion positioned around the magnet.

According to yet another exemplary embodiment of the present disclosure, a method of manufacturing a rotor assembly is provided including the steps of: providing a rotor shaft core defining a through hole; positioning the rotor shaft core in a mold with a magnet disposed around the rotor shaft core; and molding a rotor body and an impeller on the rotor shaft core.

In certain embodiments, the molding step includes forming the rotor body and the impeller together as an integral one-piece structure.

In certain embodiments, the molding step includes molding an inner body portion of the rotor body between the magnet and the rotor shaft core, and after molding the inner body portion, molding an outer body portion of the rotor body onto to inner body portion to encapsulate the magnet between the outer and inner body portions.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a cross-sectional view of a prior art rotor assembly of a water pump;

FIG. 2 is a partial cross-sectional view of a water pump including a first rotor assembly of the present disclosure;

FIG. 3 is an assembled perspective view of the first rotor assembly of FIG. 2;

FIG. 4 is a cross-sectional view of the first rotor assembly of FIG. 2;

FIG. 5 is an exploded perspective view of the first rotor assembly of FIG. 2;

FIG. 6 is a partial cross-sectional view of the first rotor assembly shown during the manufacturing process;

FIG. 7 is an assembled perspective view of a second rotor assembly of the present disclosure;

FIG. 8 is a cross-sectional view of the second rotor assembly of FIG. 7;

FIG. 9 is an exploded perspective view of the second rotor assembly of FIG. 7;

FIG. 10 is a partial cross-sectional view of the second rotor assembly shown during the manufacturing process;

FIG. 11 is an assembled perspective view of a third rotor assembly of the present disclosure;

FIG. 12 is a cross-sectional view of the third rotor assembly of FIG. 11;

FIG. 13 is an exploded perspective view of the third rotor assembly of FIG. 11;

FIG. 14 is a partial cross-sectional view of the third rotor assembly shown during the manufacturing process;

FIG. 15 is an alternative rotor shaft core for use in the third rotor assembly of FIG. 11;

FIG. 16 is an assembled perspective view of a fourth rotor assembly of the present disclosure;

FIG. 17 is a cross-sectional view of the fourth rotor assembly of FIG. 16;

FIG. 18 is an exploded perspective view of the fourth rotor assembly of FIG. 16; and

FIGS. 19 and 20 are partial cross-sectional views of the fourth rotor assembly shown during the manufacturing process.

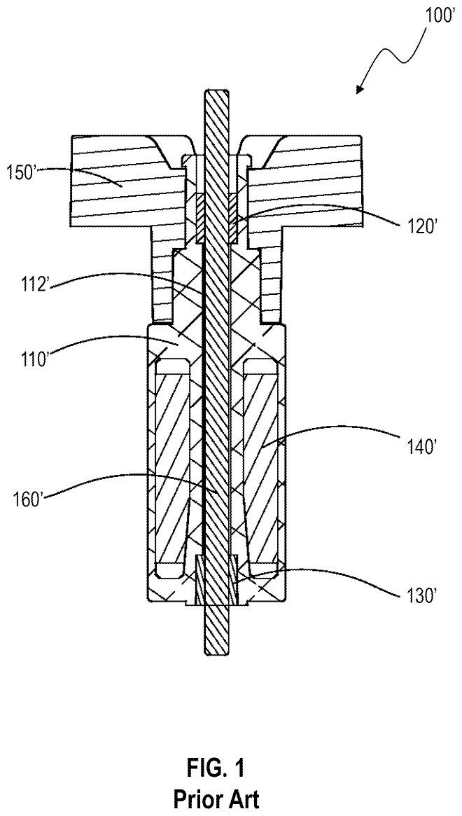

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

### I. Water Pump

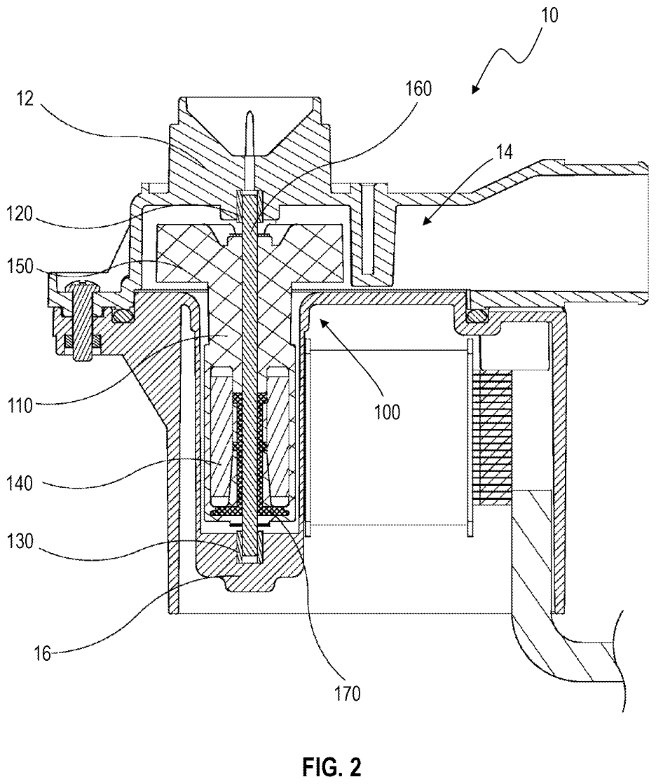

An exemplary water pump 10 is shown in FIG. 2. The water pump 10 may be associated with a pool or spa, specifically an above-ground pool or spa. The water pump 10 may direct water from the pool or spa through a filter, a heater, a chlorinator, a nozzle, or other pool or spa equipment, for example.

The illustrative water pump 10 includes an upper housing 12 that defines a waterway 14 and a lower housing 16 that cooperates with the upper housing 12 to contain a rotor assembly 100. The rotor assembly 100 is described further below. Although the water pump 10 is shown with the rotor assembly 100, it is also within the scope of the present disclosure for the water pump 10 to include other rotor assemblies, such as rotor assemblies 200, 300, 400 of the present disclosure. In operation, the rotor assembly 100 rotates in the lower housing 16 to pump water through the waterway 14 of the upper housing 12.

The illustrative water pump 10 also includes a drive assembly (not shown) configured to generate a rotating magnetic field around the rotor assembly 100 to rotate the rotor assembly 100. In certain embodiments, the drive assembly is a magnetic-type drive assembly that generates the rotating magnetic field with a drive magnet attached to a motor-driven shaft. In other embodiments, the drive assembly is an electromagnetic-type drive assembly that generates the rotating magnetic field with a current-carrying stator.

Certain directional terminology is used herein for convenience only. For example, words such as “upper”, “lower”, “above”, and “below” merely describe the illustrated orientation of the referenced components. Indeed, the referenced components may be oriented in any direction.

### II. First Rotor Assembly

Referring still to FIG. 2, the first rotor assembly 100 includes a rotor body 110, an upper bearing 120, a lower bearing 130, a magnet 140, an impeller 150, a shaft 160, and a rotor shaft core 170. The rotor body 110, the impeller 150, and the rotor shaft core 170 may be constructed of plastic materials, while the upper bearing 120, the lower bearing 130, and the shaft 160 may be constructed of non-plastic (e.g., ceramic) materials.

The upper bearing 120 and the lower bearing 130 of the illustrative rotor assembly 100 may be spaced apart from the rotor body 110. As shown in FIG. 2, the upper bearing 120 is spaced apart from the upper end of the rotor body 110 and the impeller 150 and is supported by the upper housing 12 of the water pump 10, and the lower bearing 130 is spaced apart from the lower end of the rotor body 110 and is supported by the lower housing 16 of the water pump 10. The bearings 120, 130 are concentric and are positioned in axial alignment with the shaft 160. As described further below, the magnet 140 and the rotor shaft core 170 are also concentric with the bearings 120, 130.

In operation, the above-described magnetic field of the water pump 10 rotates the magnet 140 of the rotor assembly 100. As the magnet 140 rotates, the rotor body 110, the impeller 150, the shaft 160, and the rotor shaft core 170 all rotate together with the magnet 140 relative to the bearings 120, 130. The rotating impeller 150 directs water through the waterway 14 of the water pump 10.

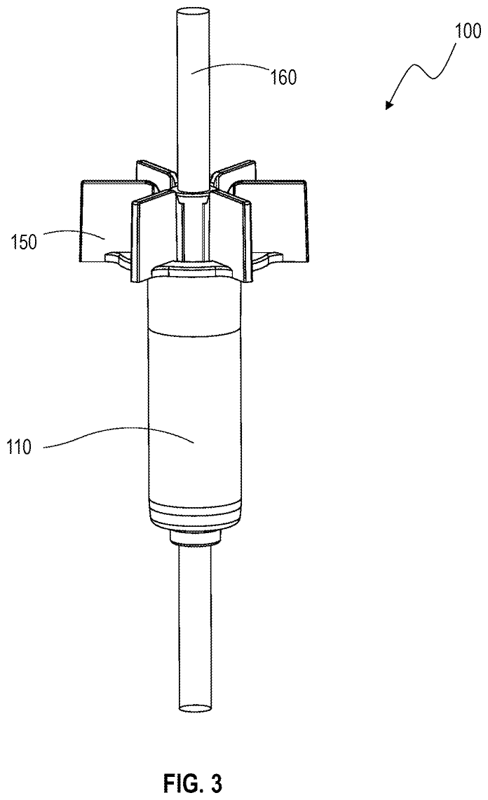

The first rotor assembly 100 is described further below with reference to FIGS. 3-5.

The rotor body 110 of the illustrative rotor assembly 100 includes an axial through hole 112. At its upper end, the rotor body 110 may be integrally formed with the impeller 150 as a one-piece structure, or the rotor body 110 and the impeller 150 may be formed as two separate pieces that are coupled together. At its lower end, the rotor body 110 may wrap beneath the magnet 140 and the rotor shaft core 170.

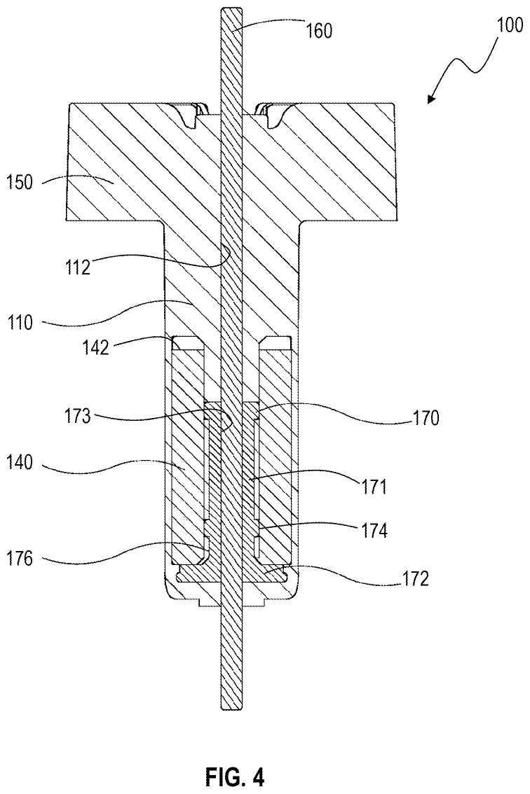

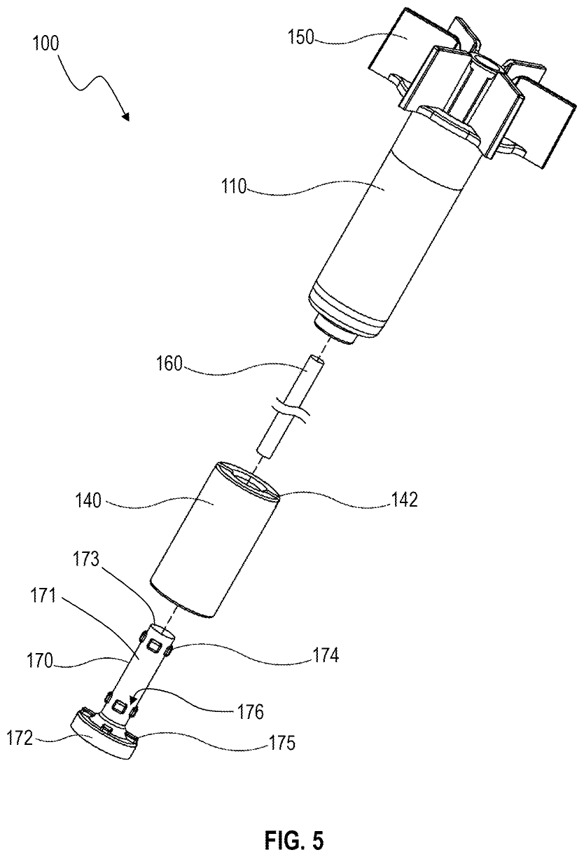

The magnet 140 of the illustrative rotor assembly 100 is tubular in shape and is encapsulated in a waterproof manner. As shown in FIG. 4, the rotor body 110 and the rotor shaft core 170 cooperate to encapsulate the magnet 140, with the rotor body 110 covering the outer and upper sides of the magnet 140 and with the rotor body 110 and the rotor shaft core 170 together covering the inner and lower sides of the magnet 140. As shown in FIG. 5, the magnet 140 includes an interlocking feature, specifically slots 142 extending radially across an upper surface of the magnet 140. The rotor body 110 may occupy these slots 142, thereby strengthening the connection of the rotor body 110 to the magnet 140 and preventing axial or rotational movement between the rotor body 110 and the magnet 140.

The shaft 160 of the illustrative rotor assembly 100 extends through the through hole 112 of the rotor body 110. The upper end of the shaft 160 extends upward above the rotor body 110 and the impeller 150 and is supported by the upper bearing 120 (FIG. 2), and the lower end of the shaft 160 extends downward below the rotor body 110 and is supported by the lower bearing 130 (FIG. 2). The shaft 160 is coupled to the adjacent rotor body 110 and rotor shaft core 170 and is configured to rotate with the rotor body 110 and the rotor shaft core 170 relative to the bearings 120, 130 (FIG. 2).

The rotor shaft core 170 of the illustrative rotor assembly 100 is a generally T-shaped tubular structure having an axial portion 171, a radial portion 172, and an axial through hole 173. As shown in FIG. 4, the through hole 173 of the rotor shaft core 170 is axially aligned with the through hole 112 of the rotor body 110 such that the shaft 160 extends through both the through hole 173 of the rotor shaft core 170 and the through hole 112 of the rotor body 110. With the rotor shaft core 170 surrounding the shaft 160, the axial portion 171 of the rotor shaft core 170 is sleeved between the magnet 140 and the shaft 160 to maintain the relative positioning and concentricity of the magnet 140 and the shaft 160. The radial portion 172 of the rotor shaft core 170 extends radially outward from the axial portion 171 to support the magnet 140 and limit axial movement of the magnet 140. As shown in FIGS. 4 and 5, the rotor shaft core 170 also includes interlocking features, specifically upper protrusions 174 circumferentially arranged on the axial portion 171 and extending radially outward toward the magnet 140 and/or lower protrusions 175 circumferentially arranged on the radial portion 172 and extending upward toward the magnet 140. The rotor body 110 may occupy gaps 176 between the protrusions 174, 175, thereby strengthening the connection of the rotor body 110 to the rotor shaft core 170 and ensuring watertight encapsulation of the magnet 140.

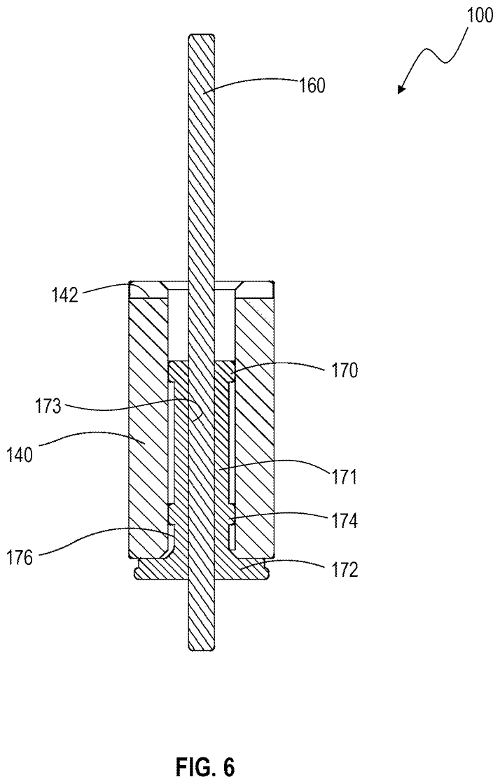

The rotor assembly 100 may be manufactured according to the following process. First, the rotor shaft core 170 is injection molded or otherwise formed. Second, as shown in FIG. 6, the magnet 140 is positioned around the molded rotor shaft core 170, and the shaft 160 is inserted in the through hole 173 of the molded rotor shaft core 170. Third, as shown in FIG. 4, the rotor body 110 (and optionally the impeller 150) is overmolded onto the magnet 140, the shaft 160, and the rotor shaft core 170. This overmolding step may allow the rotor body 110 to fill various interlocking features, such as the slots 142 in the magnet 140 and the gaps 176 in the rotor shaft core 170. Fourth, as shown in FIG. 2, the upper bearing 120 is inserted into the upper housing 12 of the water pump 10, and the lower bearing 130 is inserted into the lower housing 16 of the water pump 10 concentrically with the upper bearing 120. In one embodiment, this inserting step involves measuring and identifying concentric locations on the housings 12, 16, machining (e.g., drilling) those concentric locations of the housings 12, 16, and then adhering and/or friction-fitting the bearings 120, 130 into the machined housings 12, 16. Finally, the housings 12, 16, are positioned on opposing ends of the shaft 160 and fastened together to enclose the molded rotor assembly 100 within the water pump 10. This manufacturing process may be efficient and consistent. Additionally, this process may ensure that the rotor assembly 100 is properly balanced in the water pump 10, thereby minimizing vibrations and wear in the water pump 10 and prolonging the service life of the water pump 10.

### III. Second Rotor Assembly

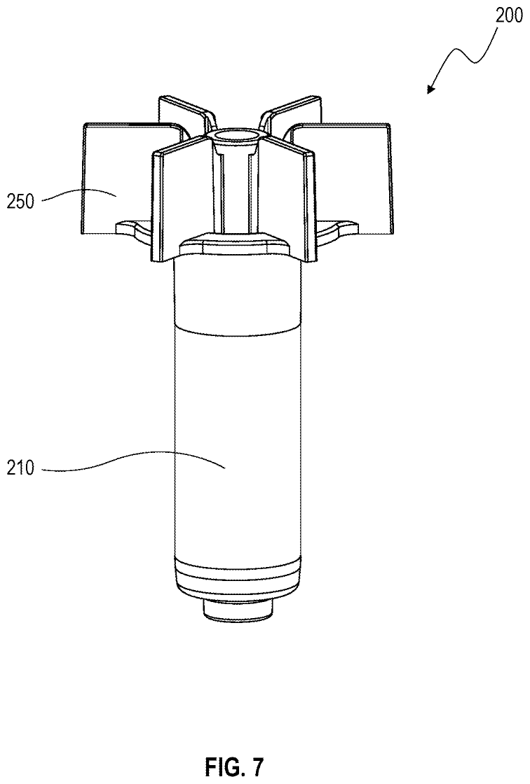

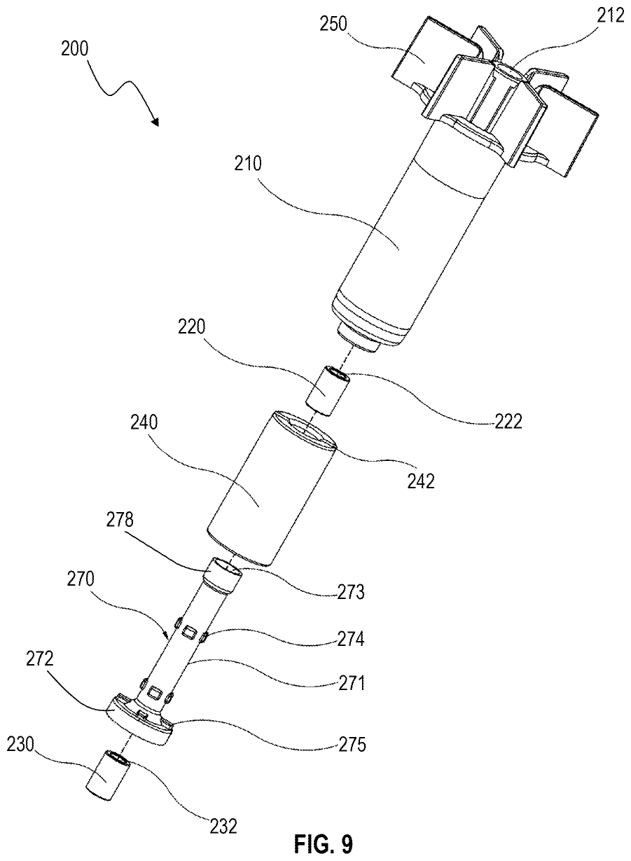

Referring next to FIGS. 7-9, a second rotor assembly 200 is provided for use in a water pump similar to water pump 10 (FIG. 2). The second rotor assembly 200 is similar to the first rotor assembly 100, with like reference numerals identifying like elements, except as described below.

The second rotor assembly 200 includes a rotor body 210 having a through hole 212, an upper bearing 220 having a through hole 222, a lower bearing 230 having a through hole 232, a magnet 240 having slots 242, an impeller 250, a shaft (not shown), and a rotor shaft core 270. Unlike the bearings 120, 130 of the first rotor assembly 100 which are spaced apart from the rotor body 110 (FIG. 2), the bearings 220, 230 of the second rotor assembly 200 are supported by the rotor body 210.

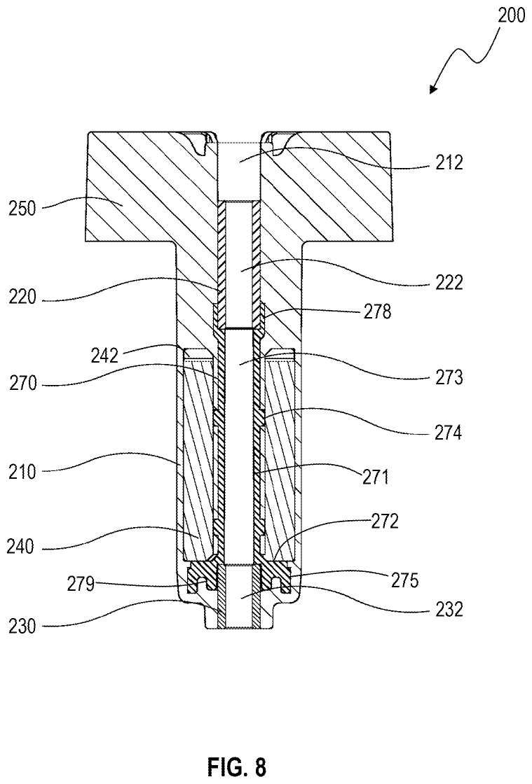

The rotor shaft core 270 of the illustrative rotor assembly 200 is a generally T-shaped tubular structure having an axial portion 271, a radial portion 272, and an axial through hole 273. The rotor shaft core 270 also includes protrusions 274, 275 to strengthen the connection of the rotor body 210 to the rotor shaft core 270 and ensure a watertight encapsulation of the magnet 240, as described above. Additionally, the rotor shaft core 270 includes an enlarged upper rim 278 sized to receive the upper bearing 220 and an enlarged lower rim 279 sized to receive the lower bearing 230. The enlarged rims 278, 279 of the rotor shaft core 270 may limit axial movement of the bearings 220, 230. Also, the enlarged rims 278, 279 of the rotor shaft core 270 may ensure that the bearings 220, 230 are concentric and in axial alignment with the shaft (not shown), such that the shaft passes through the through hole 212 of the rotor body 210, the through hole 222 of the upper bearing 220, the through hole 273 of the rotor shaft core 270, and the through hole 232 of the lower bearing 230. As shown in FIG. 8, the through hole 212 of the rotor body 210 and the through hole 273 of the rotor shaft core 270 may be larger in diameter than the through holes 222, 232 of the bearings 220, 230, such that, during rotation, the shaft (not shown) contacts the bearings 220, 230, without contacting the rotor body 210 or the rotor shaft core 270.

In operation, the above-described magnetic field rotates the magnet 240 of the rotor assembly 200. As the magnet 240 rotates, the rotor body 210, the bearings 220, 230, the impeller 250, and the rotor shaft core 270 all rotate together with the magnet 240 relative to the shaft (not shown) to pump water.

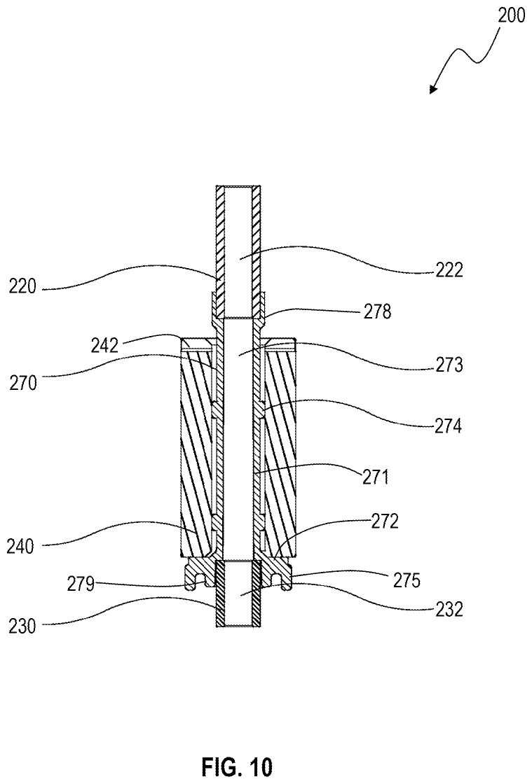

The rotor assembly 200 may be manufactured according to the following process. First, the rotor shaft core 270 is injection molded or otherwise formed. Second, as shown in FIG. 10, the bearings 220, 230 are inserted in the corresponding rims 278, 279 of the molded rotor shaft core 270, and the magnet 240 is positioned around the molded rotor shaft core 270. Third, as shown in FIG. 8, the rotor body 210 (and optionally the impeller 250) is overmolded onto the bearings 220, 230, the magnet 240, and the rotor shaft core 270. During this overmolding step, one or more mold cores may block the through hole 222 of the upper bearing 220, the through hole 273 of the rotor shaft core 270, and the through hole 232 of the lower bearing 230 to prevent the overmolded material from entering and/or filling these through holes 222, 273, 232. The same mold core(s) may also be used to form the through hole 212 in the rotor body 210. Finally, the molded rotor assembly 200 is removed from the mold and the shaft (not shown) is inserted through the aligned through holes 212, 222, 273, 232. This manufacturing process may be efficient and consistent. Additionally, this process may ensure that the rotor assembly 200 is properly balanced, thereby minimizing vibrations and wear and prolonging the service life.

### IV. Third Rotor Assembly

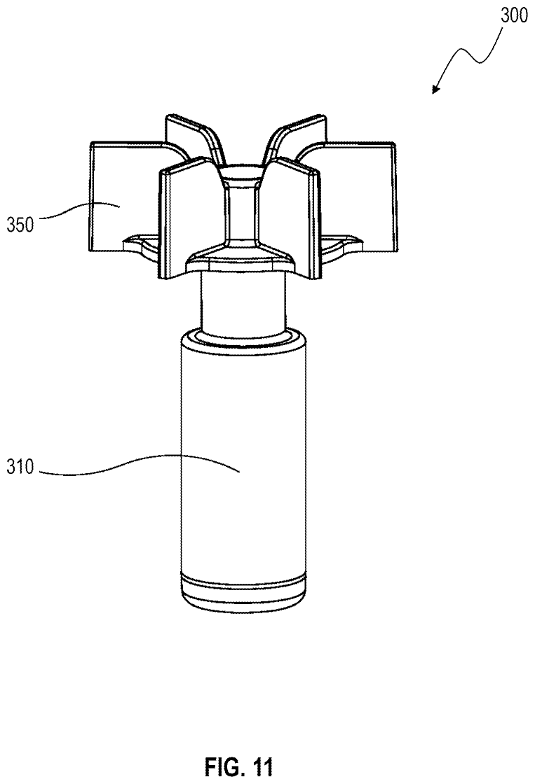

Referring next to FIGS. 11-13, a third rotor assembly 300 is provided for use in a water pump similar to water pump 10 (FIG. 2). The third rotor assembly 300 is similar to the first rotor assembly 100 and the second rotor assembly 200, with like reference numerals identifying like elements, except as described below.

The third rotor assembly 300 includes a rotor body 310 having a through hole 312, an upper bearing 320 having a through hole 322, a lower bearing 330 having a through hole 332, a magnet 340 having slots 342, an impeller 350, a shaft (not shown), and a rotor shaft core 370 having a through hole 373. Like the bearings 220, 230 of the second rotor assembly 200 (FIG. 8), the bearings 320, 330 of the third rotor assembly 300 are supported by the rotor body 310.

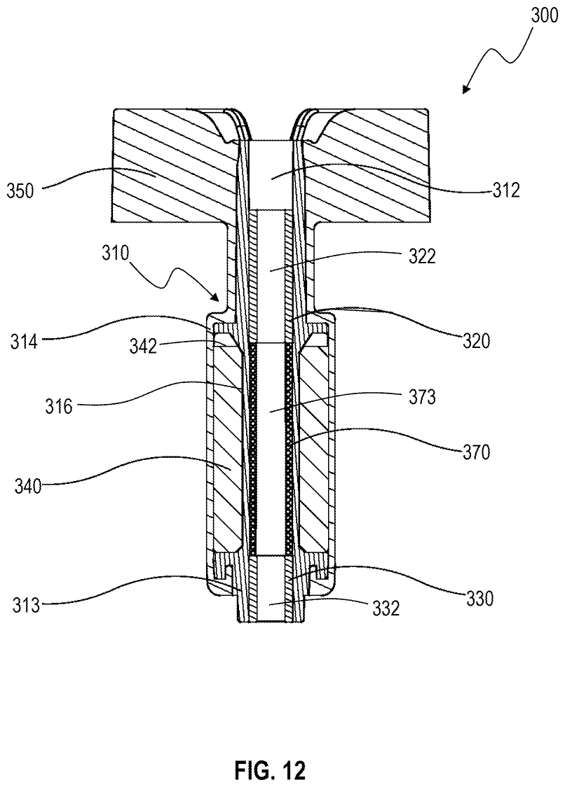

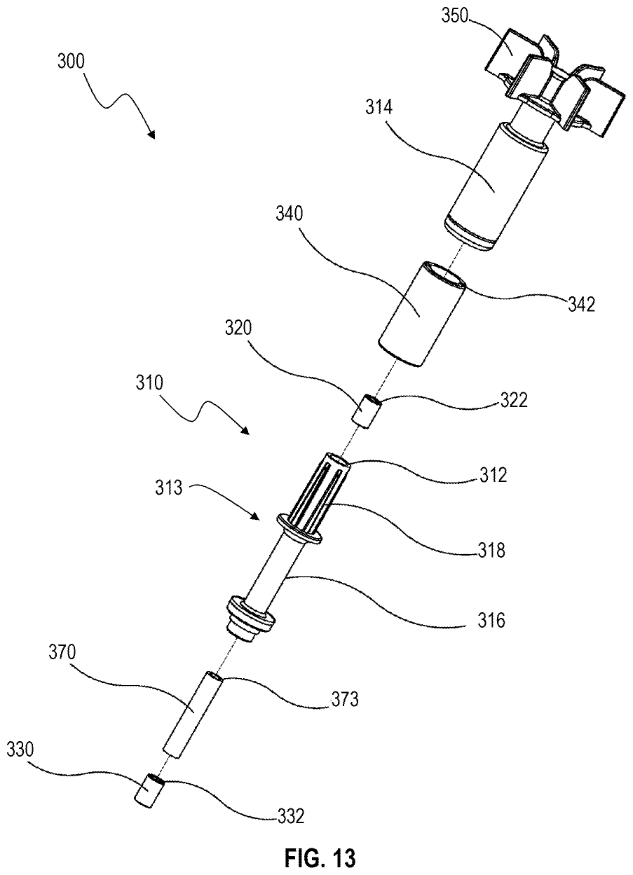

The rotor body 310 of the illustrative rotor assembly 300 is a two-piece structure including an inner body portion 313 that defines the through hole 312 and an outer body portion 314 that surrounds the inner body portion 313. As shown in FIGS. 12 and 13, the lower end of the inner body portion 313 defines a groove 316 that is sized to capture and encapsulate the magnet 340 between the inner body portion 313 and the outer body portion 314. As shown in FIG. 13, the upper end of the inner body portion 313 includes a plurality of interlocking features, specifically longitudinal grooves 318. The outer body portion 314 may occupy these grooves 318, thereby strengthening the connection of the outer body portion 314 to the inner body portion 313 and preventing axial or rotational movement between the outer body portion 314 and the inner body portion 313. The outer body portion 314 may be integrally formed with the impeller 350 as a one-piece structure, or the outer body portion 314 and the impeller 350 may be formed as two separate pieces that are coupled together.

The rotor shaft core 370 of the illustrative rotor assembly 300 is a simple tubular structure sized for receipt between the bearings 320, 330. As shown in FIG. 12, the through hole 312 of the rotor body 310 and the through hole 373 of the rotor shaft core 370 may be larger in diameter than the through holes 322, 332 of the bearings 320, 330, such that, during rotation, the shaft (not shown) contacts the bearings 320, 330, without contacting the rotor body 310 or the rotor shaft core 370.

In operation, the above-described magnetic field rotates the magnet 340 of the rotor assembly 300. As the magnet 340 rotates, the body portions 313, 314, of the rotor body 310, the bearings 320, 330, the impeller 350, and the rotor shaft core 370 all rotate together with the magnet 340 relative to the shaft (not shown) to pump water.

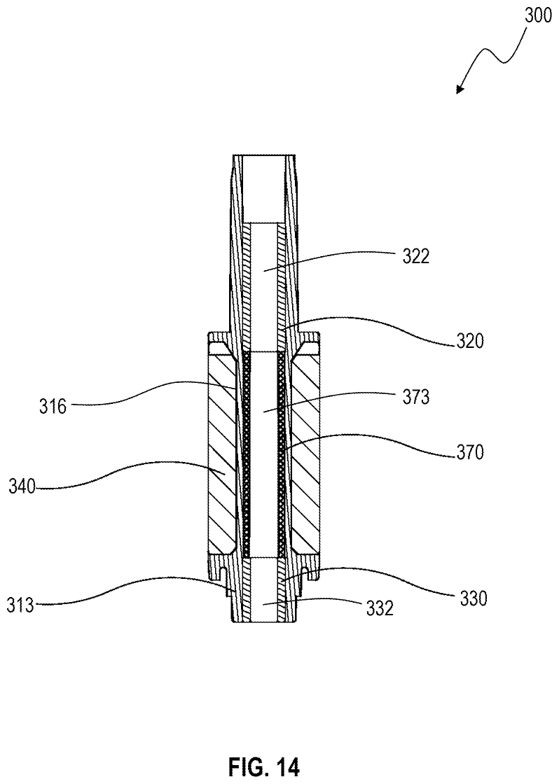

The rotor assembly 300 may be manufactured according to the following process. First, the rotor shaft core 370 is injection molded or otherwise formed. Second, as shown in FIG. 14, the bearings 320, 330, the magnet 340, and the molded rotor shaft core 370 are arranged in a mold. Third, as shown in FIG. 14, the inner body portion 313 of the rotor body 310 is overmolded onto the bearings 320, 330, the magnet 340, and the rotor shaft core 370, including the area between the magnet 340 and the rotor shaft core 370. Fourth, as shown in FIG. 12, the outer body portion 314 of the rotor body 310 (and optionally the impeller 350) is overmolded onto the previously-molded inner body portion 313 of the rotor body 310 to encapsulate the magnet 340. During these overmolding steps, one or more mold cores may block the through hole 322 of the upper bearing 320, the through hole 373 of the rotor shaft core 370, and the through hole 332 of the lower bearing 330 to prevent the overmolded material from entering and/or filling these through holes 322, 373, 332. The same mold core(s) may also be used to form the through hole 312 in the inner body portion 313 of the rotor body 310. Finally, the molded rotor assembly 300 is removed from the mold and the shaft (not shown) is inserted through the aligned through holes 312, 322, 373, 332. This manufacturing process may be efficient and consistent. Additionally, this process may ensure that the rotor assembly 300 is properly balanced, thereby minimizing vibrations and wear and prolonging the service life.

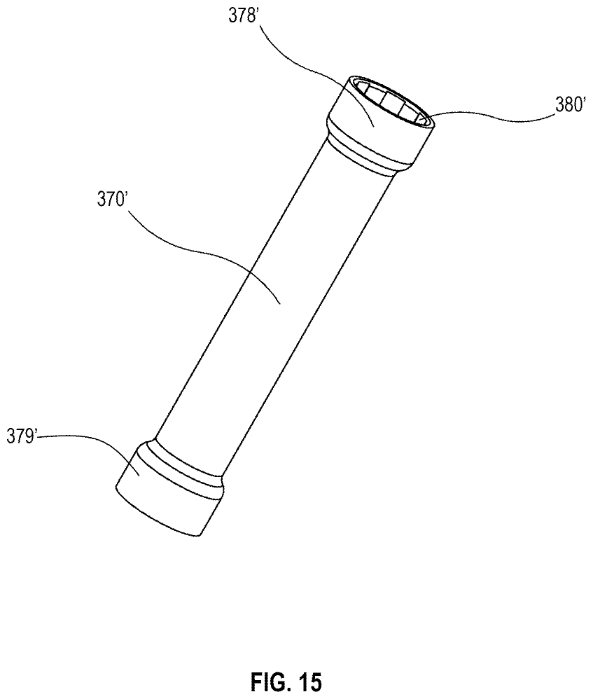

Referring next to FIG. 15, another rotor shaft core 370′ is provided for use in the rotor assembly 300. Rather than being a simple tubular structure like the rotor shaft core 370 of FIG. 13, the rotor shaft core 370′ of FIG. 15 includes an enlarged upper rim 378′ sized to receive the upper bearing 320 (FIG. 13) and an enlarged lower rim 379′ sized to receive the lower bearing 330 (FIG. 13). The enlarged rims 378′, 379′ of the rotor shaft core 370′ may limit axial movement of the bearings 320, 330. Also, the enlarged rims 378′, 379′ of the rotor shaft core 370′ may ensure that the bearings 320, 330 are concentric and in axial alignment with the shaft (not shown). As shown in FIG. 15, the enlarged rims 378′, 379′, may have internal splines 380′ that cooperate with external splines (not shown) on the bearings 320, 330, to prevent rotation of the bearings 320, 333, relative to the rotor shaft core 370′.

### V. Fourth Rotor Assembly

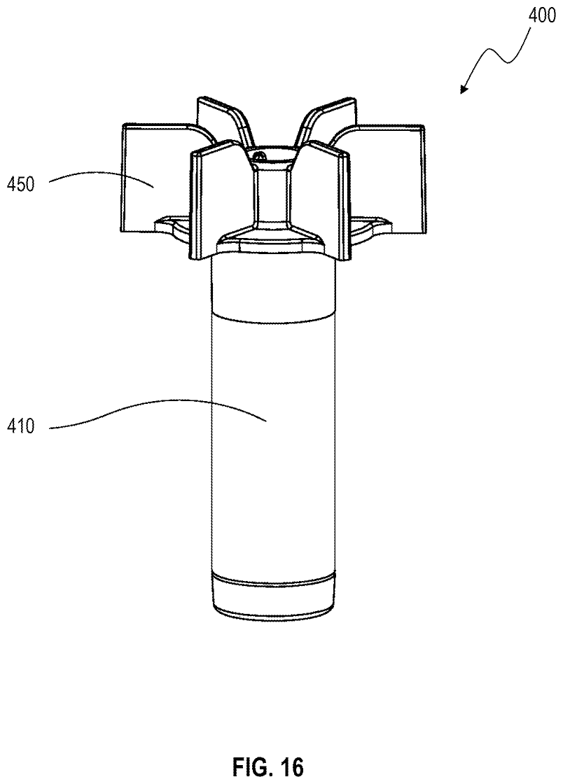

Referring next to FIGS. 16-18, a fourth rotor assembly 400 is provided for use in a water pump similar to water pump 10 (FIG. 2). The fourth rotor assembly 400 is similar to the first rotor assembly 100, the second rotor assembly 200, and the third rotor assembly 300, with like reference numerals identifying like elements, except as described below.

The fourth rotor assembly 400 includes a rotor body 410 having a through hole 412, an upper bearing 420 having a through hole 422, a lower bearing 430 having a through hole 432, a magnet 440 having slots 442, an impeller 450, a shaft (not shown), and a flexible bearing casing 490 having a through hole 492. Like the bearings 220, 230 of the second rotor assembly 200 (FIG. 8) and the bearings 320, 330 of the third rotor assembly 300 (FIG. 12), the bearings 420, 430 of the fourth rotor assembly 400 are supported by the rotor body 410.

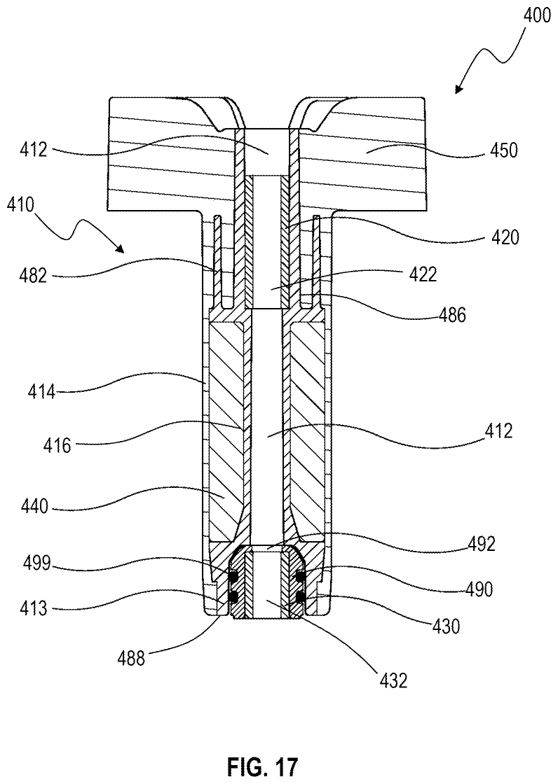

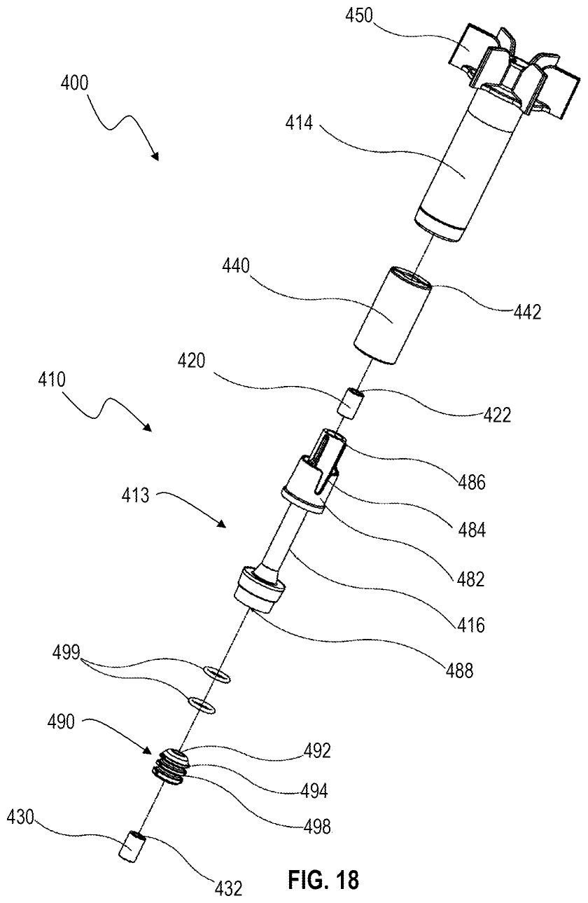

The rotor body 410 of the illustrative rotor assembly 400 is a two-piece structure including an inner body portion 413 that defines the through hole 412 and an outer body portion 414 that surrounds the inner body portion 413. As shown in FIGS. 17 and 18, the lower end of the inner body portion 413 defines a groove 416 that is sized to capture and encapsulate the magnet 440 between the inner body portion 413 and the outer body portion 414. Also, the upper end of the inner body portion 413 includes a plurality of interlocking features, specifically an axial flange 482 with grooves 484. The outer body portion 414 may surround the flange 482 and occupy these grooves 484, thereby strengthening the connection of the outer body portion 414 to the inner body portion 313 and preventing axial or rotational movement between the outer body portion 414 and the inner body portion 413. The outer body portion 414 may be integrally formed with the impeller 450 as a one-piece structure, or the outer body portion 414 and the impeller 450 may be formed as two separate pieces that are coupled together.

The rotor body 410, specifically the inner body portion 413 of the rotor body 410, may further include an enlarged upper rim 486 sized to receive the upper bearing 420 and an enlarged lower rim 488 sized to receive the lower bearing 430 and the flexible bearing casing 490. The enlarged rims 486, 488 may limit axial movement of the bearings 420, 430 and ensure that the bearings 420, 430 are concentric and in axial alignment with the shaft (not shown) in the through hole 412. As such, the enlarged rims 486, 488 may be similar to the enlarged rims 278, 279 of the above-described rotor shaft core 270 (FIG. 8) and the enlarged rims 378′, 379′ of the above-described rotor shaft core 370′ (FIG. 15).

The flexible bearing casing 490 of the illustrative rotor assembly 400 receives the lower bearing 430 in its through hole 492. The bearing casing 490 may be made of a soft material (e.g., rubber) and can serve as a buffer medium between the lower bearing 430 and the rotor body 410. If the upper bearing 420 and the lower bearing 430 are offset and not concentric, the lower bearing 430 can press against and deform the bearing casing 490, thereby restoring the concentricity of the upper bearing 420 and the lower bearing 430. As shown in FIG. 18, to facilitate quick mounting of the bearing casing 490 in the rotor body 410, the bearing casing 490 may include a mounting lug 494, and the through hole 412 of the rotor body 410 may include a corresponding mounting groove (not shown) sized to receive the mounting lug 494. Also, to enhance the adjustability of the bearing casing 490 relative to the rotor body 410, the bearing casing 490 may include one or more circumferential grooves 498 that receive corresponding adjustment rings or seals 499 (i.e., O-rings). Compared to the bearing casing 490 itself, the rings 499 have a small volume and strong strain capacity, enabling the through hole 492 of the bearing casing 490 casing to be tilted, shifted, or otherwise adjusted relative to the rotor body 410.

In operation, the above-described magnetic field rotates the magnet 440 of the rotor assembly 400. As the magnet 440 rotates, the body portions 413, 414, of the rotor body 410, the bearings 420, 430, the impeller 450, and the bearing casing 490 all rotate together with the magnet 440 relative to the shaft (not shown) to pump water.

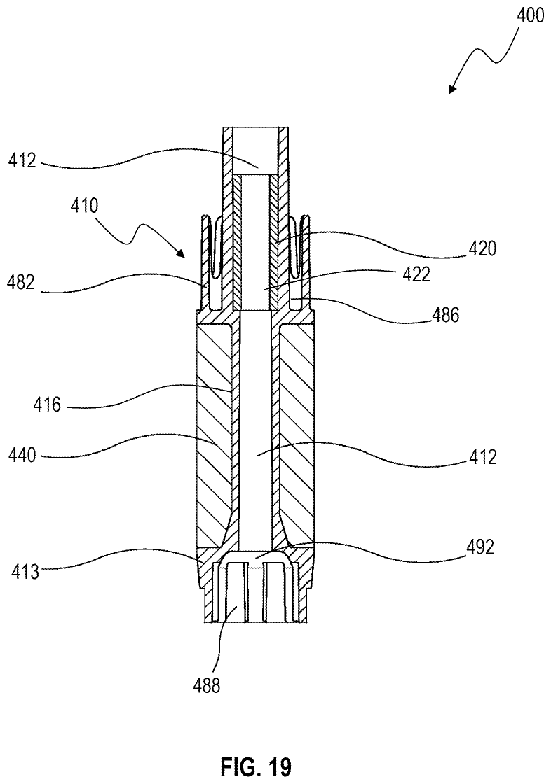

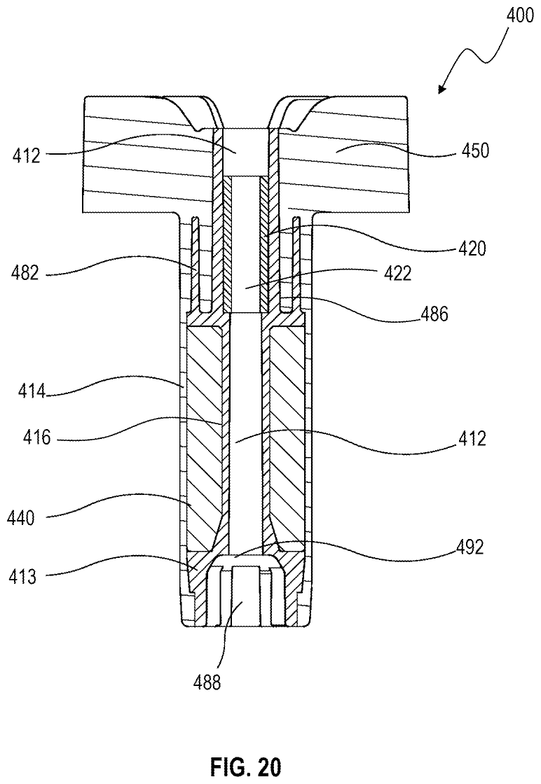

The rotor assembly 400 may be manufactured according to the following process. First, as shown in FIG. 19, the upper bearing 420 and the magnet 440 are arranged in a mold. Second, the inner body portion 413 of the rotor body 410 is overmolded onto the upper bearing 420 and the magnet 440. Third, as shown in FIG. 20, the outer body portion 414 of the rotor body 410 (and optionally the impeller 450) is overmolded onto the previously-molded inner body portion 413 of the rotor body 410 to encapsulate the magnet 440. During these overmolding steps, one or more mold cores may block the through hole 422 of the upper bearing 420. The same mold core(s) may also be used to form the through hole 412 in the inner body portion 413 of the rotor body 410. Fourth, as shown in FIG. 17, the lower bearing 430 and the bearing casing 490 are pressed into the enlarged lower rim 488 of the rotor body 410 with the rings 499 engaging the inner body portion 413 of the rotor body 410. Finally, the molded rotor assembly 400 is removed from the mold, and the shaft (not shown) is inserted through the aligned through holes 412, 422, 492, 432. This manufacturing process may be efficient and consistent. Additionally, this process may ensure that the rotor assembly 400 is properly balanced, thereby minimizing vibrations and wear and prolonging the service life.

Although the bearing casing 490 of the present disclosure is associated with the lower bearing 430, this arrangement may vary. In one embodiment, the bearing casing 490 may be associated with the upper bearing 420 and used in combination with a rigid lower bearing 430. In another embodiment, multiple bearing casings 490 may be used and associated with both bearings 420, 430. It is also within the scope of the present disclosure for the bearing casing 490 to be used with the above-described rotor assemblies 100, 200, 300. It is further within the scope of the present disclosure for an existing rotor assembly to be retrofit to receive the bearing casing 490 for improved alignment.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A rotor assembly comprising:
a rotor shaft core defining a through hole configured to receive a shaft;
a magnet;
a rotor body overmolded onto the rotor shaft core to encapsulate the magnet between the rotor body and the rotor shaft core;
an impeller coupled to the rotor body;
an upper bearing defining a through hole in axial alignment with the through hole of the rotor shaft core; and
a lower bearing defining a through hole in axial alignment with the through hole of the rotor shaft core.

2. The rotor assembly of claim 1, wherein the upper bearing and the lower bearing are supported by the rotor body and configured to rotate about the shaft.

3. The rotor assembly of claim 1, wherein the through hole of the rotor shaft core has a smaller diameter than the upper bearing and the lower bearing such that the shaft contacts the upper bearing and the lower bearing without contacting the rotor shaft core.

4. The rotor assembly of claim 1, wherein the rotor shaft core includes an axial portion and a radial portion that extends radially outward from the axial portion to support the magnet.

5. The rotor assembly of claim 4, wherein the axial portion of the rotor shaft core includes a first plurality of protrusions that extend radially outward toward the magnet.

6. The rotor assembly of claim 5, wherein the rotor body occupies areas between the first plurality of protrusions.

7. The rotor assembly of claim 4, wherein the radial portion of the rotor shaft core includes a second plurality of protrusions that extend axially toward the magnet.

8. The rotor assembly of claim 7, wherein the rotor body occupies areas between the second plurality of protrusions.

9. The rotor assembly of claim 1, wherein the rotor shaft core includes an enlarged upper rim that receives the upper bearing and an enlarged lower rim that receives the lower bearing.

10. The rotor assembly of claim 1, wherein the rotor body and the impeller form an integral one-piece structure.

11. A rotor assembly comprising:
a magnet;
a rotor shaft core defining a through hole configured to receive a shaft, the rotor shaft core maintaining concentricity between the magnet and the through hole;
a rotor body overmolded onto the rotor shaft core to encapsulate the magnet between the rotor body and the rotor shaft core; and
an impeller coupled to the rotor body.

12. The rotor assembly of claim 11, further comprising:
an upper bearing configured to support an upper end of the shaft; and
a lower bearing configured to support a lower end of the shaft.

13. The rotor assembly of claim 11, wherein the upper and lower bearings are supported by the rotor body such that the upper and lower bearings rotate with the rotor body.

14. The rotor assembly of claim 13, wherein the rotor shaft core includes an enlarged upper rim that receives the upper bearing and an enlarged lower rim that receives the lower bearing.

15. The rotor assembly of claim 11, wherein the upper and lower bearings are spaced apart from the rotor body such that the rotor body rotates relative to the upper and lower bearings.

16. The rotor assembly of claim 11, further comprising a flexible bearing casing around one or more of the upper and lower bearings.

17. The rotor assembly of claim 11, wherein the rotor body and the impeller form an integral one-piece structure.

18. The rotor assembly of claim 11, wherein the rotor body is a two-piece structure including an inner body portion positioned between the magnet and the rotor shaft core and an outer body portion positioned around the magnet.

19. A method of manufacturing a rotor assembly comprising the steps of:
providing a rotor shaft core defining a through hole;
positioning the rotor shaft core in a mold with a magnet disposed around the rotor shaft core; and
molding a rotor body and an impeller on the rotor shaft core.

20. The method of claim 19, wherein the molding step comprises forming the rotor body and the impeller together as an integral one-piece structure.

21. The method of claim 19, wherein the molding step comprises:
molding an inner body portion of the rotor body between the magnet and the rotor shaft core; and
after molding the inner body portion, molding an outer body portion of the rotor body onto to inner body portion to encapsulate the magnet between the outer and inner body portions.
